(19) United States
(12) Patent Application Publication
(10) Pub. No.: US 2007/0080901 A1
(43) Pub. Date: Apr. 12, 2007

(54) Plasma display device and driving method thereof

(76) Inventors: Hak-Cheol Yang, Suwon-si (KR); Joon-Yeon Kim, Suwon-si (KR); Hyun-Gu Heo, Suwon-si (KR); Sang-Shin Kwak, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/546,617

(22) Filed: Oct. 11, 2006

(30) Foreign Application Priority Data
Oct. 12, 2005 (KR) 10-2005-0095997

(51) Int. Cl. G09G 3/28

(52) U.S. Cl. 345/63

(57) ABSTRACT

A plasma display device is disclosed. In one embodiment, the device includes a plurality of first electrodes, a plurality of second electrodes, and a plurality of third electrodes formed to cross the first and second electrodes. A first voltage is alternately applied to the plurality of first and second electrodes using a first address scheme for converting on-cells into an off-cell state during a sustain period at a first subfield, and a second address scheme is used to convert the off-cells into an on-cell state at a second subfield. During a first period between the first and second subfields, a voltage is applied to the plurality of first and second electrodes such that a voltage difference between the plurality of first and second electrodes is greater than the first voltage. With such a first period, even when the write address scheme and the erase address scheme are used together, the initializing is performed appropriately.

### CROSS-REFERENCE TO RELATED APPLICATION

This application claims priority to and the benefit of Korean Patent Application No. 10-2005-0095997 filed in the Korean Intellectual Property Office on Oct. 12, 2005, the entire contents of which is incorporated herein by reference.

### BACKGROUND OF THE INVENTION

(a) Field of the Invention

The present invention relates to a plasma display device and a driving method thereof.

(b) Description of the Related Art

A plasma display panel (PDP) is a flat panel display that uses plasma generated by gas discharge to display characters or images.

According to a driving method of such a plasma display device, one frame is divided into a plurality of subfields, each having weight values.

Each subfield has an address period in which an address operation for selecting discharge cells to emit light from among a plurality of discharge cells, and a sustain period in which a sustain discharge occurs in the selected discharge cells to perform a display operation.

At this time, in order to select a turn-on discharge cell (or on-cell) among discharge cells formed at regions at which display lines and address electrodes cross, a scan pulse is applied to the respective display lines. Also, in order to apply a scan pulse to the respective display lines, scan circuits for selecting the respective display lines are provided. Such scan circuits are connected to correspond to the scan electrodes.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect of the present invention provides a plasma display device and a driving method thereof having advantages of reducing the number of scan circuits and normally generating a weak discharge during a main reset period.

Another aspect of the present invention provides a driving method of a plasma display device having a plurality of first electrodes, a plurality of second electrodes, and a plurality of third electrodes formed crossing the first electrodes and the second electrodes is provided. The driving method includes, at a first subfield, selecting light-emitting cells using a first address scheme for converting the state of the light-emitting cells to a non-light-emitting cell state during an address period, alternately applying a first voltage that is a sustain discharge voltage to the plurality of first and second electrodes during a sustain period, and increasing a second voltage corresponding to a voltage difference between the plurality of first and second electrodes to a third voltage that is greater than the first voltage during a first period; and at a second subfield, generating a sustain discharge after selecting the light-emitting cells using a second address scheme for converting the non-light-emitting cell state to the light-emitting cell state.

Another aspect of the present invention provides a driving method of a plasma display device having a plurality of first electrodes, a plurality of second electrodes, and a plurality of third electrodes formed crossing the first electrodes and the second electrodes is provided. The driving method includes, at a first subfield, selecting light-emitting cells using a first address scheme for converting the state of the light-emitting cells to a non-light-emitting cell state and generating a sustain discharge in the selected cells, and during a first period, generating a discharge in the cells having been converted to the non-light-emitting cell state by the first address scheme and the cells having undergone a sustain discharge; and at a second subfield, generating a reset discharge so as to initialize all the discharged cells.

Still another aspect of the present invention provides a plasma display device is provided. The plasma display device includes a PDP including a plurality of first electrodes, a plurality of second electrodes, and a plurality of third electrodes formed crossing the first electrodes and the second electrodes; and a driver for applying a voltage such that a voltage difference between the plurality of first and second electrodes is greater than a first voltage during a first period between a first subfield and a second subfield, the first subfield alternately applying the first voltage to the plurality of first and second electrodes using a first address scheme for converting the state of light-emitting cells to a non-light-emitting cell state during a sustain period, and the second subfield using a second address scheme for converting the state of the non-light-emitting cells to the light-emitting cell state.

### BRIEF DESCRIPTION OF THE DRAWINGS

FIG. 1 is a schematic diagram of a plasma display device according to an exemplary embodiment of the present invention.

FIG. 2 is an electrode arrangement diagram of a plasma display panel according to a first exemplary embodiment of the present invention.

FIG. 3 is an electrode arrangement diagram of a plasma display panel according to a second exemplary embodiment of the present invention.

FIG. 4 shows a driving method of the plasma display device according to an exemplary embodiment of the present invention.

FIG. 5 shows driving waveforms applied to first to third subfields SF1 to SF3 among driving waveforms of a plasma display device according to an exemplary embodiment of the present invention.

FIG. 6 shows a driving waveform applied to a fourth subfield SF4 among driving waveforms of the plasma display device according to an exemplary embodiment of the present invention.

FIG. 7 shows a driving waveform applied to a fifth subfield SF5 among driving waveforms of the plasma display device according to an exemplary embodiment of the present invention.

FIG. 8 shows a driving waveform applied to a tenth subfield SF10 among driving waveforms of the plasma display device according to an exemplary embodiment of the present invention.

FIG. 9A to FIG. 9C respectively shows a wall charge state formed when applying the driving waveform of the plasma display device shown in FIG. 8.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

When it is described that an element “includes” another element, it is meant that the element may further include the other element but not excluding others.

The wall charges being described in embodiments of the present invention mean charges formed on a wall close to each electrode of a discharge cell. The wall charge will be described as being “formed” or “accumulated” on the electrode, although the wall charge do not actually touch the electrodes. Further, a wall voltage means a potential difference formed on the wall of the discharge cell by the wall charge.

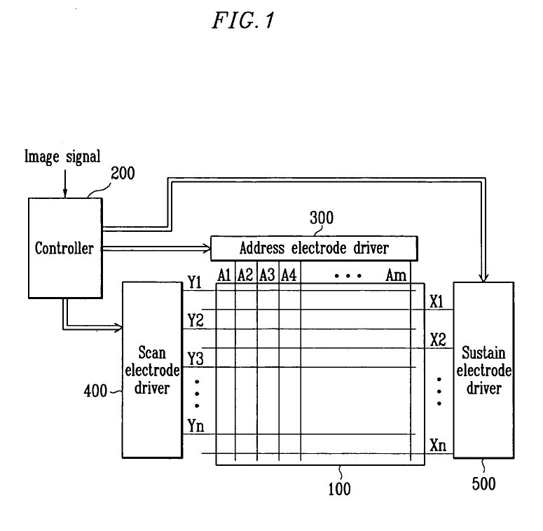

First, a configuration of a plasma display device according to an exemplary embodiment of the present invention will be described with reference to FIG. 1 through FIG. 3.

FIG. 1 shows a schematic diagram of the plasma display device according to an exemplary embodiment of the present invention.

Referring to FIG. 1, the plasma display device includes a PDP 100, a controller 200, an address electrode driver 300, a scan electrode driver 400, and a sustain electrode driver 500.

The PDP 100 includes a plurality of address electrodes A1 to Am extending in a column direction, a plurality of sustain electrodes X1 to Xn extending in a row direction, and a plurality of scan electrodes Y1 to Yn extending in a row direction.

The controller 200 receives an external video signal and outputs an address driving control signal, a sustain electrode driving control signal, and a sustain electrode driving control signal. In addition, the controller 200 controls the plasma display device by dividing a frame into a plurality of subfields having respective brightness weight values. Further, according to an exemplary embodiment of the present invention, the controller 200 controls the plasma display device such that even-numbered X electrodes (Xeven) and odd-numbered X electrodes (Xodd) of the plurality of X electrodes X1 to Xn are differently driven.

The address electrode driver 300 receives the address electrode driving control signal from the controller 200 and applies a driving voltage to the address electrodes.

The scan electrode driver 400 receives the scan electrode driving control signal from the controller 200 and applies a driving voltage to the scan electrodes.

The sustain electrode driver 500 receives the sustain electrode driving control signal from the controller 200 and applies a driving voltage to the sustain electrodes.

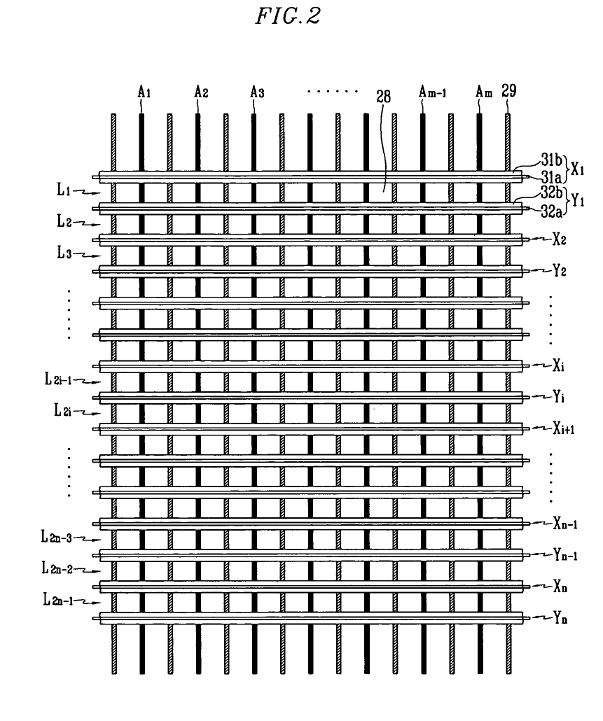

FIG. 2 shows an electrode arrangement diagram of a plasma display panel according to an exemplary embodiment of the present invention.

As shown in FIG. 2, the PDP 100 includes one substrate having the sustain and scan electrodes X1 to Xn and Y1 to Yn formed thereon, and another substrate having the address electrodes A1 to Am formed thereon. The two substrates are disposed to face each other. Display lines L1 to L2n−1 for displaying images are formed between the scan electrodes Y1 to Yn and the sustain electrodes X1 to Xn, formed so as to alternate with respect to the Y1 to Yn, respectively, to be adjacent to each other. For example, a display line L1 may be formed between a first scan electrode Y1 and a first sustain electrode X1, and a display line L2 may be formed between a first scan electrode Y1 and a second sustain electrode X2. That is, one scan electrode Yi forms two display lines L2i−1 and L2i with the upper and lower adjacent sustain electrodes Xi and X(i+1).

Discharge cells 28 are formed at respective discharge spaces formed at regions which these display lines L1 to L2n−1 cross the address electrodes A1 to Am. The discharge cells 28 are partitioned in the row direction by barrier ribs 29. Such sustain electrodes X1 to Xn and scan electrodes Y1 to Yn include bus electrodes 31a and 32a having a narrow width and transparent electrodes 31b and 32b having a wide width, which are extended in a row direction. The transparent electrodes 31b and 32b are respectively connected with the bus electrodes 31a and 32a. Alternatively, only the bus electrodes 31a and 32a may form the sustain and scan electrodes without the transparent electrodes 31b and 32b, or only the transparent electrodes 31b and 32b may form the sustain and scan electrodes without the bus electrodes 31a and 32a. In addition, barrier ribs (not shown in FIG.2) may be formed on the bus electrodes 31a and 32a so that the discharge cells 28 are partitioned in a column direction by the barrier ribs.

According to a first exemplary embodiment of the present invention, since the sustain and scan electrodes are arranged such that they respectively share the two adjacent display lines, it is possible to reduce the number of sustain and scan electrodes in comparison with the conventional structure that uses one sustain electrode and one scan electrode for one display line. For example, when 512 display lines are driven, 512 sustain and scan electrodes are required in the conventional plasma display panel. However, according to one embodiment of the present invention, it is sufficient for the plasma display panel to have half of 512 sustain and scan electrodes because of the shared structure. In this embodiment, the PDP 100 may have approximately twice the number of display lines as the number of scan and sustain electrodes. Accordingly, given the same resolution, the number of scan and sustain electrodes in one embodiment of the invention may be reduced approximately by half compared to the conventional PDP.

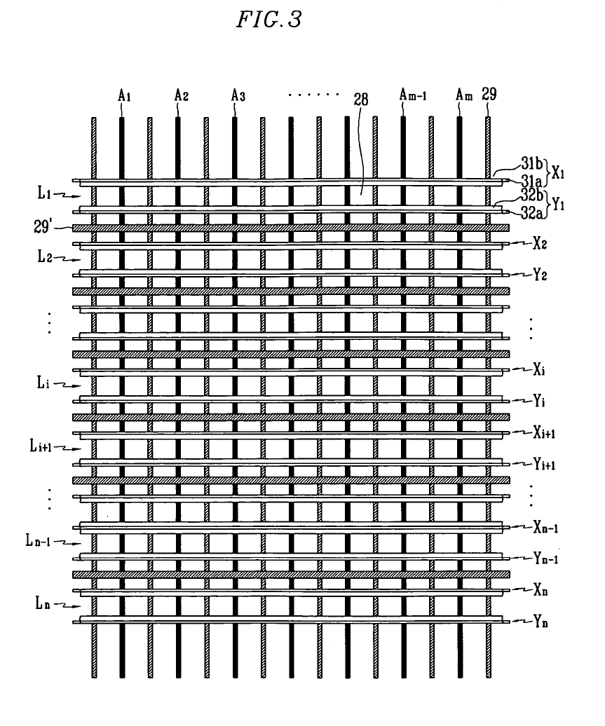

Such a structure of the PDP 100 is merely one example. Accordingly, other panel structures may be applied to an exemplary embodiment of the present invention if the driving waveforms described below can be applied. FIG. 3 is an electrode arrangement diagram of a plasma display panel according to a second exemplary embodiment of the present invention.

The difference between the FIG. 2 and FIG. 3 embodiments is that the sustain and scan electrodes in the FIG. 3 embodiment share only one display line. That is, the PDP of FIG. 3 has a barrier rib 29′ formed between the scan electrode Yi and the sustain electrode Xi+1, and accordingly, the display line is formed only between the same order of the sustain and scan electrodes Xi and Yi. In addition, unlike as shown in FIG. 1, the transparent electrodes 31b and 32b may be formed biased to the display line because the display line is formed between the same order of the sustain and scan electrodes Xi and Yi.

Therefore, the number of display lines is reduced to half (i.e., n) in comparison with the first exemplary embodiment. Accordingly, when a PDP is designed to have the same resolution as that of the first exemplary embodiment, the number of sustain and scan electrodes is doubled. However, in the case of the electrode arrangement according to the second exemplary embodiment, a scan pulse is simultaneously applied to two scan electrodes during the respective address periods when a driving method described below is applied. In this case, the driving method described below may be equally applied except that one scan circuit is connected to two scan electrodes so that the scan pulse is simultaneously applied to two scan electrodes during the respective address periods.

A driving method of a plasma display device having a PDP structure according to the first and second exemplary embodiments of the present invention will be described hereinafter. For convenience of description, a driving method of a plasma display device will be described based on only the PDP of the first exemplary embodiment of the present invention shown in FIG. 2. The PDP driving method for the second exemplary embodiment is substantially the same as the driving method described below except that the scan pulse is simultaneously applied to the two scan electrodes during the respective address periods. However, the driving methods described below can be applied to other PDP structures where an erase address and a write address are used.

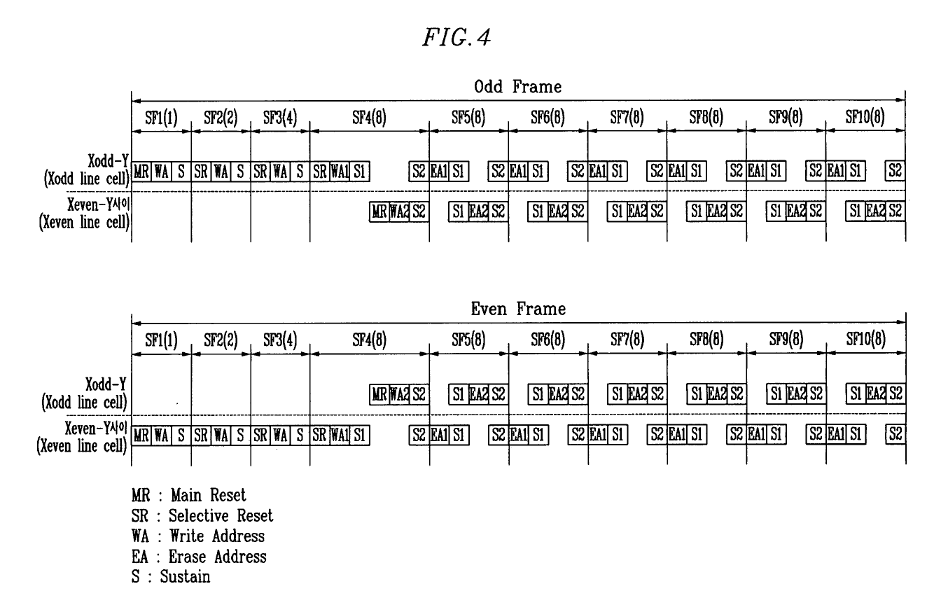

FIG. 4 is a driving method of a plasma display device according to an exemplary embodiment of the present invention.

Hereinafter, an “Xodd line cell” is referred to as a discharge cell on the display lines formed between the odd-numbered sustain electrodes (Xodd) and the scan electrodes Y1 to Yn, and an “Xeven line cell” is referred to as a discharge cell on the display lines formed between the even-numbered sustain electrodes (Xeven) and the scan electrodes Y1 to Yn. In addition, a discharge cell having wall charges appropriately formed to generate a sustain discharge during the sustain period is called a “light-emitting cell (or on-cell)”, and a discharge cell having wall charges appropriately formed to not generate a sustain discharge during the sustain period is called a “non-light-emitting cell (or off-cell)”. In addition, a “main reset period MR” represents a reset period for generating a reset discharge in all cells that have undergone or have not undergone the sustain discharge at the previous subfield, thereby initializing all the cells, and a “selective reset period SR” represents a reset period for generating a reset discharge in only the cells that have undergone a sustain discharge at the previous subfield, thereby initializing only the same. Meanwhile, a “write address period WA” is referred to as one address period for applying an addressing method (i.e., a write addressing method) for generating an address discharge such that a non-light-emitting cell state is changed to a light-emitting cell state, and an “erase address period EA” is referred to as another address period for applying an addressing method (i.e., an erase addressing method) for generating an address discharge such that a light-emitting cell state is changed to a non-light-emitting cell state.

In one embodiment, as shown in FIG. 4, a driving method of a plasma display device is different according to an odd-numbered frame or an even-numbered frame, wherein each frame is divided into a plurality of subfields SF1 to SF10. Each subfield SF1 to SF10 has a predetermined weight value to display a grayscale. In an exemplary embodiment of the present invention, the weight value of each subfield SF1 to SF10 is expressed in order as {1, 2, 4, 8, 8, 8, 8, 8, 8, 8}. However, other weight values may be established.

At the first to third subfields SF1 to SF3 of the odd-numbered frame, the respective subfield is operated for the Xodd line cells and is not operated for the Xeven line cells. In addition, at the first to third subfields SF1 to SF3 of the even-numbered frame, the respective subfield is operated for the Xeven line cells and is not operated for the Xodd line cell. As a result, the first to third subfields SF1 to SF3 emit light every two frames. That is, low grayscales of the first to third subfields SF1 to SF3 express all cells through two frames, i.e., one odd-numbered frame and one even-numbered frame. In another embodiment, the subfields for the low grayscales may be changed to, for example, SF1 to SF2, SF1 to SF4 or SF1 to SF5 depending on applications.

The first subfield SF1 of the odd-numbered frame includes a main reset period MR, a write address period WA, and a sustain period S. Subsequently, the second and third subfields SF2 and SF3 respectively include a selective reset period SR, a write address period WA, and a sustain period S. As described above, at the first to third subfields SF1 to SF3 of the odd-numbered frame, the reset period, the address period, and the sustain period are performed only for the Xodd line cells. Meanwhile, in FIG. 4, the reset periods of the second and third subfields SF2 and SF3 are set as the selective reset period SR so as to reduce a reset period and to enhance contrast. However, it is obvious that the selective reset period SR may be replaced with the main reset period MR.

Subsequently, at the fourth subfield SF4 of the odd-numbered frame, the main reset period MR, a first write address period WA1, and a first sustain period S1 are sequentially performed for the Xodd line cells, and then the main reset period MR, the first write address period WA1, and the second sustain period S2 are sequentially performed for the Xeven line cells. At this time, the main reset period MR is performed for the Xeven line cells to initialize the same because no operations are performed for the Xeven line cells at previous subfields (i.e., the first to third subfields SF1 to SF3). When the sustain discharge is generated at the second sustain period S2, the sustain discharge is repeatedly generated for the Xodd line cell because the sustain discharge had been generated during the first sustain period S1.

At the fifth to tenth subfields SF5 to SF10, each subfield is operated for all the cells Xodd and Xeven. The fifth to tenth subfields SF5 to SF10 respectively include erase address periods EA1 and EA2 and sustain periods S1 and S2. At the fifth to tenth subfields SF5 to SF10, the first erase address period EA1 and the first sustain period S1 are sequentially performed for the Xodd line cells, and then the second erase address period EA2 and the second sustain period S2 are sequentially performed for the Xeven line cell. All the cells that had undergone a sustain discharge during the sustain period of the fourth subfield SF4 are in the light-emitting cell state. Accordingly, at the erase periods EA1 and EA2 of the fifth subfield SF5, the cells to be selected among the light-emitting cells are set as the non-light-emitting cell state. In addition, at the respective erase address periods EA1 and EA2 of the sixth to tenth subfields SF6 to SF10, the cells to be set as the non-light-emitting cell state are selected among the cells (i.e., light-emitting cells) that have undergone a sustain discharge at the sustain period of the previous subfield. In FIG. 4, when the sustain periods S1 and S2 are described for all the Xeven line cells as well as the Xodd line cells, the sustain pulse is applied to all the odd-numbered and even-numbered sustain electrodes Xodd and Xeven so that the sustain discharge is generated at all of the Xodd and Xeven line cells.

Meanwhile, a driving method of the even-numbered frame is substantially the same as that of the odd-numbered frame except that the operation order is reversed for the Xodd line cells and the Xeven line cells. Accordingly, the driving method of the even-numbered frame will not be described in detail. That is, at the first to the third subfields SF1 to SF3 of the even-numbered frame, the reset period, the write address period, and the sustain period are respectively performed only for the Xeven line cells, and at the fourth subfield SF4, the reset period, the write address period, and the sustain period are respectively performed for the Xeven line cells and then for the Xodd line cells. In addition, at the fifth to tenth subfields SF5 to SF10 of the even-numbered frame, the erase address period and the sustain period are respectively performed for the Xeven line cells and then for the Xodd line cells.

In FIG. 4, it is expressed that the weight values of the fifth to tenth subfields SF5 to SF10 are respectively equal to that of the fourth subfield SF4. This is because the predetermined cells selected as the non-emitting cells during the erase address period cannot be changed into the light-emitting cell state at the next subfields because of application of the erase addressing scheme. The weight values of the fifth to tenth subfields SF5 to SF10 respectively may be set to be higher than 8. However, in this case, all 256 grayscales are not expressed. Accordingly, a dithering scheme is used to express the non-expressed grayscales.

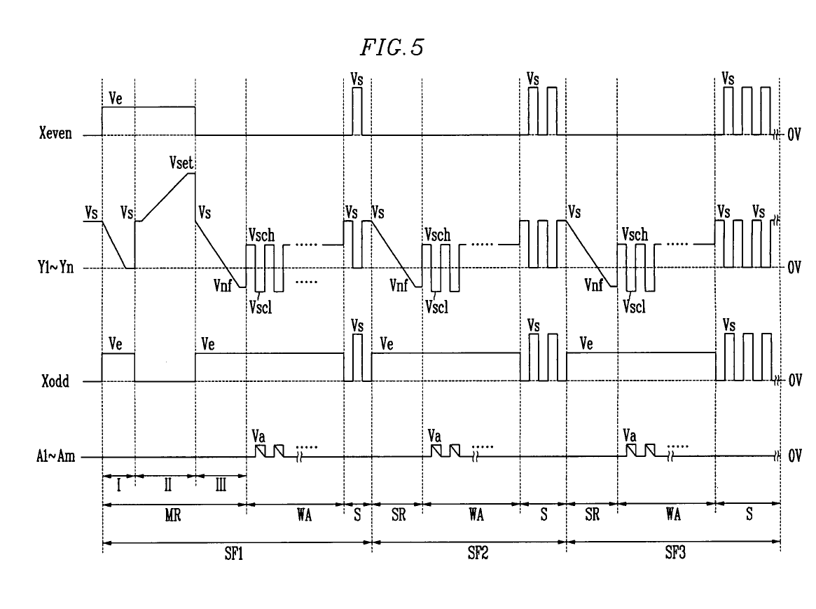

A driving waveform of a plasma display panel according to a first embodiment of the present invention is hereinafter described in detail with reference to FIG. 5 to FIG. 9. Driving waveforms shown in FIG. 5 to FIG. 9 are those applied to the odd-numbered frames. Driving waveforms applied to the even-numbered frames are the same as those applied to the odd-numbered frames except that a driving waveform applied to the odd-numbered sustain electrode Xodd is reversed with a driving waveform applied to the even-numbered sustain electrode Xeven. For convenience of description, the driving waveforms applied to the even-numbered frames will not be described. Therefore, the driving waveform applied to the odd-numbered frame will be mainly described.

FIG. 5 shows driving waveforms applied to first to third subfields SF1 to SF3 among driving waveforms of a plasma display device according to an exemplary embodiment of the present invention.

As shown in FIG. 5, the first subfield includes the main reset period MR, the write address period WA, and the sustain period S, and the second and third subfields respectively include the selective reset period SR, the write address period WA, and the sustain period S.

The main reset period MR of the first subfield SF1 includes an erase period I, a rising period II, and a falling period III.

During the erase period I of the main reset period MR, a voltage of the scan electrodes Y1 to Yn gradually decreases from a voltage Vs to a reference voltage (0V in FIG. 5), while a voltage Ve is applied to the odd-numbered and even-numbered sustain electrodes Xodd and Xeven. Such waveform of the erase period I eliminates positive (+) or negative (−) wall charges respectively formed on the sustain and scan electrodes of the cells that have undergone the sustain discharge at the previous subfield of the first subfield SF1. As a result, a state of the cells that have undergone a sustain discharge at the previous subfield of the first subfield SF1 is similar to that of the cells that have not undergone a sustain discharge at the previous subfield. FIG. 5 shows merely one example in which a gradually decreasing waveform is applied to the scan electrodes Y1 to Yn as the erase waveform applied during the erase period of the first subfield SF1. In another embodiment, a gradually increasing waveform can be applied to the sustain electrodes Xeven and Xodd while maintaining the scan electrodes Y1 to Yn to be biased at the reference voltage 0V, or a narrow width pulse waveform for erasing a wall charge by short pulses, etc., may be used.

Subsequently, the voltage of the scan electrodes Y1 to Yn gradually increases from the voltage Vs to the voltage Vset during the rising period (II) of the main reset period (MR), while the voltage Ve and the reference voltage 0V are respectively applied to the even-numbered and odd-numbered sustain electrodes Xeven and Xodd. In addition, the reference voltage 0V is applied to the address electrodes A1 to Am. Since the reference voltage 0V is applied only to the odd-numbered sustain electrodes Xodd, a weak discharge, that is, a reset discharge is generated between the odd-numbered sustain electrodes Xodd and scan electrodes (hereinafter called “Yxo”) for forming display lines therewith among all the scan electrodes Y1 to Yn, and since the voltage Ve is applied to the even-numbered sustain electrodes Xeven, a weak discharge, that is, a reset discharge is not generated between the even-numbered sustain electrodes Xeven and the scan electrodes (hereinafter called “Yxe”) for forming display lines therewith. In the electrode arrangement of the FIG. 2 embodiment, “Yxo electrode” implies scan electrodes adjacent to the odd-numbered sustain electrodes Xodd, and in the electrode arrangement of the FIG. 3 embodiment, “Yxo electrode” implies the odd-numbered scan electrodes Yodd. Furthermore, in the electrode arrangement of the FIG. 2 embodiment, “Yxe electrode” implies scan electrode regions adjacent to the even-numbered sustain electrodes Xeven among all the scan electrodes Y1 to Yn, and in the electrode arrangement of the FIG. 3 embodiment, “Yxe electrode” implies the even-numbered scan electrodes. In addition, the weak reset discharge is generated between the scan and address electrodes Y1 to Yn and A1 to Am. Accordingly, in the case of the electrode arrangement of FIG. 2 according to the first exemplary embodiment, at all the scan electrodes Y1 to Yn, the negative (−) wall charges are formed on the regions (i.e., a transparent electrode) adjacent to the odd-numbered sustain electrodes Xodd, and in the FIG. 3 embodiment, the negative (−) wall charges are formed on the odd-numbered scan electrodes (i.e. Y1, Y3 . . . ). That is, the negative (−) wall charges are formed on the scan electrodes Yxo. In addition, the positive (+) wall charges are formed on the odd-numbered sustain electrodes Xodd and the negative (−) wall charges are formed on the address electrodes A1 to Am. That is, only the Xodd line cells are initialized by generating a reset discharge. In addition, when the voltage of the Y electrode is gradually changed as shown in FIG. 5, the wall charges are formed while the weak discharge occurs in the cells such that a sum of the voltage applied externally and a wall voltage thereof become a discharge firing voltage. Such a process of forming wall charges is disclosed in U.S. Pat. No. 5,745,086 to Weber, which is incorporated herein by reference. Meanwhile, the voltage Vset is high enough to fire a discharge in any cell states because all the cells should be initialized at the main reset period of the first subfield regardless of whether the cells have experienced a sustain discharge or not. In addition, the voltage Vs is less than the discharge firing voltage formed between the scan and sustain electrodes Y1 to Yn and X1 to Xn. The example shown in FIG. 5 is only one example in which the voltage Vs is set to be substantially the same as the sustain pulse voltage applied during the sustain period so as to reduce the number of power sources. Accordingly, the voltage Vs may be set differently. In addition, the voltage Ve is appropriately selected such that the reset discharge is not generated between the scan and sustain electrodes by a difference of the voltages Vset and Ve.

In addition, during the falling period III of the main reset period MR, the voltage applied to the scan electrodes Y1 to Yn is gradually decreased from the voltage Vs to the voltage Vnf. At this time, the reference voltage 0V is applied to the even-numbered scan electrodes Xeven, the voltage Ve is applied to the odd-numbered scan electrodes Xodd, and the reference voltage 0V is applied to the address electrodes A1 to Am. As a result, the weak reset discharge is generated between the scan electrodes Yxo and the odd-numbered sustain electrodes Xodd and between the scan and address electrodes Y1 to Xn and A1 to Am, while the voltage of the scan electrodes Y1 to Yn is decreased. Thus, the negative (−) wall charge formed on the scan electrodes Yxo, the positive (+) wall charge formed on the odd-numbered sustain electrodes Xodd, and the positive (+) wall charge formed on the address electrodes A1 to Am are erased. However, as described above, the reset discharge is not generated between the scan electrodes Yxe and the even-numbered sustain electrodes Xeven, since the weak discharge is not generated between the scan electrodes Yxe and the even-numbered sustain electrodes Xeven in the rising period II, and the reference voltage 0V is applied to the even-numbered sustain electrodes Xeven in the falling period III. Therefore, the reset discharge is generated only in the Xodd line cells so that the Xodd line cells are initialized into the non-light-emitting cell state and come to have the wall charge state appropriate for the addressing. Generally, the voltages Ve and Vnf are set such that the wall voltage between the scan electrodes Yxo and the odd-numbered sustain electrodes Xodd becomes near 0V, and accordingly, the discharge cell that has not undergone an address discharge in the address period may be prevented from misfiring in the sustain period. In addition, the wall voltage between the scan and address electrodes Yxo and A1 to Am is determined by the voltage Vnf because the address electrodes A1 to Am are maintained at the reference voltage 0V.

In such a main reset period of the first subfield SF1, the reset discharge is generated only in the Xodd line cells so that the Xodd line cells have the wall charge state appropriate for the addressing. However, the reset discharge is not generated in the Xeven line cells, and accordingly the Xeven line cells may have the wall charge state appropriate for the addressing. The wall charge state of the Xodd line cells becomes the non-light-emitting state by the reset discharge.

Subsequently, in order to select cells to have the light-emitting cell state among the Xodd line cells, during the write address WA of the first subfield SF1, in the first exemplary embodiment, a scan pulse having a voltage Vscl is sequentially applied to the scan electrodes Y1 to Yn and the voltage Vsch is applied to the scan electrodes not applied with the voltage Vscl. Furthermore, in the second exemplary embodiment, the scan pulse having the voltage Vscl is sequentially applied to two adjacent scan electrodes Y1 and Y2, Y3 to Y4, and Y5 and Y6, and the voltage Vsch is applied to the scan electrodes that are not applied with the voltage Vscl. For example, in the FIG. 2 embodiment, the scan pulse is sequentially applied to the electrodes Yi and Yi+1. However, in the FIG. 3 embodiment, the scan pulse is simultaneously applied to the electrodes Yi and Yi+1 and then the scan pulse is applied to the electrodes Yi+2 and Yi+3. In addition, the reference voltage 0V and the voltage Ve are respectively applied to the even-numbered and odd-numbered sustain electrodes Xeven and Xodd. At this time, the voltage Vscl is referred to as a scan voltage, and the voltage Vsch is referred to as a non-scan voltage. An address pulse having a voltage Va is applied to the address electrodes passing through the discharge cells to be selected among the plurality of discharge cells applied with the voltage Vscl, and the reference voltage 0V is applied to the address electrodes that are not to be selected. Then discharge is generated at the cells formed by the address electrodes applied with the voltage Va, the scan electrodes applied with the voltage Vscl, and the even-numbered sustain electrodes Xeven that are applied with the voltage Ve, and accordingly, positive (+) wall charges are formed on the scan electrodes and negative (−) wall charges are formed on the address and sustain electrodes. That is, the address discharge is generated in the cells that are applied with the voltage Va among the Xodd line cells, and accordingly the non-light-emitting cell state is changed to the light-emitting cell state. However, the Xeven line cells are not initialized during the main reset period MR of the first subfield, and during the write address period (WR), the even-numbered sustain electrodes Xeven are biased at the reference voltage and accordingly the address discharge is not generated in the Xeven line cells. Meanwhile, the address pulses are applied to the selected address electrodes, because the discharge cells are selected among the Xodd line cells during the write address period WA of the first subfield SF1.

As such, in order to select cells to emit light in the sustain period during the write address period WA of the first subfield SF1, the corresponding cells among the Xodd line discharge cells generate a discharge and form the wall charges thereon such that the non-light-emitting cell state is changed to the light-emitting cell state.

In the sustain period S of the first subfield SF1, a sustain pulse having a sustain discharge voltage Vs is alternately applied to the scan electrodes Y1 to Yn and the sustain electrodes Xodd and Xeven. By means of such a sustain pulse, the sustain discharge is generated in the predetermined cells during the write address period WA of the first subfield, such that the predetermined cells come to have the light-emitting cell state. In this case, the number of sustain pulses is selected appropriately for the weight values of the first subfield.

A driving waveform applied to the second and third subfields SF2 and SF3 is substantially the same as the driving waveform applied to the first subfield SF1, except that the different driving waveform is applied in the reset period. Accordingly, it is not described in detail.

As shown in FIG. 5, the reset period of the second and third subfields SF2 and SF3 is given as the selective reset period SR. Accordingly, the voltage of the scan electrodes Y1 to Yn does not gradually increase, but gradually decreases from the voltage Vs to the voltage Vnf so that the reset discharge is generated in only the sustain discharge cells during the respective previous subfields.

The negative (−) wall discharges and the positive (+) wall charges are respectively formed on the scan and sustain electrodes of the cells that have experienced a sustain discharge (that is, the cells that have undergone a sustain discharge during the first subfield among the Xodd line cells), because the last sustain pulse is applied to the scan electrodes Y1 to Yn during the sustain period of the first subfield SF1, that is, the previous subfield of the second subfield SF2. The voltage that has gradually decreased from the voltage Vs to the voltage Vnf is applied to the scan electrodes Y1 to Yn, while the reference voltage 0V and the voltage Ve are respectively to the even-numbered and odd-numbered sustain electrodes Xeven and Xodd. The reset discharge is then generated in the cells that have undergone a sustain discharge during the sustain period of the first subfield SF1. However, the reset discharge is not generated in the cells that have not undergone a sustain discharge during the sustain period of the first subfield SF1 among the Xodd line cells since the cells maintain the wall charge state of the main reset period MR of the first subfield SF1. That is, because the cells that have not experienced a sustain discharge during the first subfield SF1 among the Xodd line cells maintain the wall charge state after the main reset period MR, the reset discharge is not needed again in the cells. Accordingly, by applying the voltage that decreases from the voltage Vs to the voltage Vnf to the scan electrodes Y1 to Yn, the reset discharge is generated only in the cells that have undergone a sustain discharge during the first subfield SF1. Meanwhile, since the voltage Ve is only applied to the odd-numbered sustain electrodes Xodd in the selective reset period SR of the second subfield, the reset discharge is generated only in the cells that have undergone a sustain discharge during the first subfield SF1. Therefore, all the Xodd line cells are initialized to the non-light-emitting cell state because the reset discharge is generated in the cells that have undergone a sustain discharge during the selective reset period SR of the second subfield SF2, and the state of the wall charges after the main reset period MR of the first subfield SF1 is maintained in the cells that have not undergone a sustain discharge in the first subfield SF1 among the Xodd line cells.

Meanwhile, the selective reset period SR of the third subfield SF3 is operated in the same manner as the reset period SR of the second subfield. Accordingly, the driving method of the selective period SR of the third subfield SF3 will not be described in detail. The respective sustain periods of the second subfield SF2 and the third subfield SF3 have the number of sustain discharge pulses set appropriately for the weight values of the corresponding subfield.

Through such a driving waveform shown in FIG. 5, the reset operation, the write address operation, and the sustain discharge are performed only for the Xodd line cells at the first to third subfields SF1 to SF3.

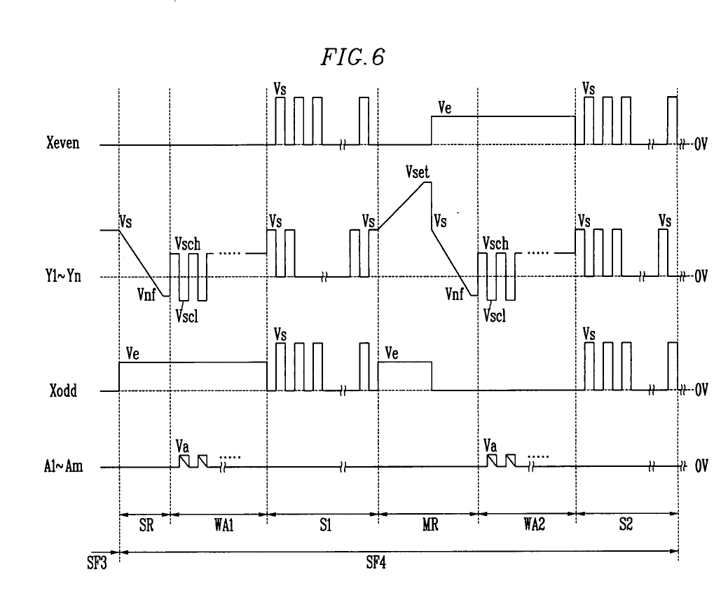

FIG. 6 shows a driving waveform applied to the fourth subfield SF4 among a driving waveform of a plasma display device according to an exemplary embodiment of the present invention.

First, a selective reset period SR, a first write address period WA1, and a first sustain period S1 are performed for the Xodd line cells. As shown in FIG. 6, the selective reset period SR, the first write address period WA1, and the first sustain period S1 are performed in the same manner as the second subfield SF2 or the third subfield SF3 except that a different number of sustain pulses is applied at the first sustain period S1 so as to express the weight values of the fourth subfield. Accordingly, they will not be described in detail. That is, during the selective reset period SR, the voltage of the scan electrodes Y1 to Yn gradually decreases from the voltage Vs to the voltage Vnf while the voltage Ve is applied only to the odd-numbered sustain electrodes Xodd, and accordingly, the reset operation is performed so as to initialize the Xodd line cells into the non-light-emitting cell state. Subsequently, during the first write address period WA1, the write address operation is performed to select the cells for the light-emitting cell state among the Xodd line cells, and during the first sustain period S1, the sustain discharge operation is performed by alternately applying the sustain pulse to the scan electrodes Y1 to Yn and the sustain electrodes Xeven and Xodd.

Subsequently, the main reset period MR, the second write address period WA2, and the second sustain period S2 are performed for the Xeven line cells.

As shown in FIG. 6, after gradually increasing a voltage of the scan electrodes Y1 to Yn from the voltage Vs to the voltage Vset while the reference voltage 0V and the voltage Ve are respectively applied to the even-numbered and odd-numbered sustain electrodes Xeven and Xodd during the main reset period MR, the voltage that gradually decreases from the voltage Vs to the voltage Vnf is applied to the scan electrodes Y1 to Yn while the voltage Ve and the reference voltage 0V are respectively applied to the even-numbered and odd-numbered sustain electrodes Xeven and Xodd. That is, the inverse driving waveforms are applied to the even-numbered and odd-numbered sustain electrodes Xeven and Xodd during the main reset period MR of the first subfield SF1 as shown in FIG.5. Therefore, the reset discharge is generated only in the Xeven line cells so that only the Xeven line cells are initialized into the non-light-emitting state.

Subsequently, the write address operation is performed only for the Xeven line cells, because the voltage Ve and the reference voltage 0V are respectively applied to the even-numbered and odd-numbered sustain electrodes Xeven and Xodd even during the second write address period WA2 in the inverse of the write address period WA of the first subfield SF1.

In addition, the sustain pulse is alternately applied to the scan and sustain electrodes Y1 to Yn and Xeven and Xodd so that the sustain discharge is generated only in the cells selected during the second sustain period S2. At this time, the cells that have undergone a sustain discharge during the first sustain period S1 may not generate a discharge during the main reset period MR and the second write address period WA2, and accordingly the light-emitting cell state is maintained. Thus, even the cells that have completed a sustain discharge in the first sustain period S1 may generate a sustain discharge when the sustain pulse is applied during the second sustain period S2. That is, the predetermined cells that are selected as the light-emitting cells in the second write address period WA2 as well as in the first write address period WA1 undergo a sustain discharge during the second sustain period S2. Therefore, the Xodd line cells undergo a greater number of sustain discharges than the Xeven line cells because the Xodd line cells undergo a sustain discharge during the first and second sustain periods. The number difference of the sustain discharges generated between the Xodd and Xeven line cells during the fourth subfield SF4 is supplemented as described below, and accordingly, it is controlled such that the same number of sustain discharges are generated.

The negative (−) wall charge and the positive (+) wall charges respectively form on the scan and sustain electrodes of the cells that have completed a sustain discharge during the first sustain period S1 because the last sustain pulse is applied to the scan electrodes Y1 to Yn during the first sustain period S1 of the fourth subfield. Accordingly, a wall voltage Vwxy is formed between the sustain and scan electrodes such that a potential of the scan electrodes becomes higher than the same of the sustain electrodes.

The state of the wall charges is maintained even at the finishing point of the main reset period MR because the reset discharge is not generated during the main reset period MR.

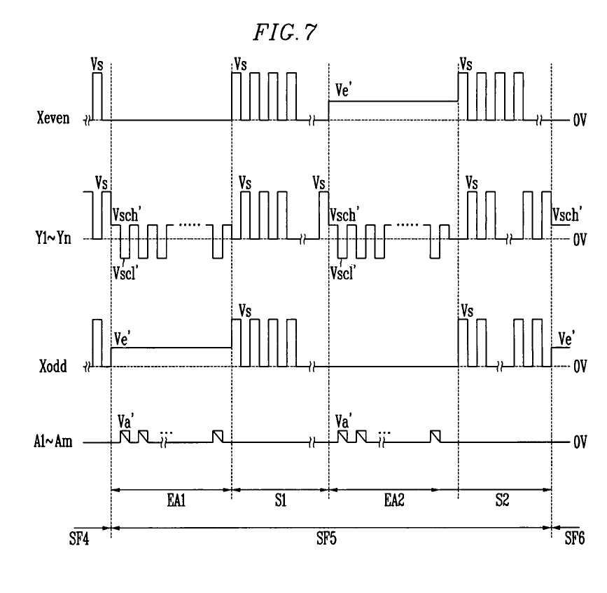

FIG. 7 shows a driving waveform applied to a fifth subfield SF5 among driving waveforms of the plasma display device according to the exemplary embodiment of the present invention.

As shown in FIG. 7, the fifth subfield SF5 includes the first erase address period EA1 and the first sustain period S1 applied for the Xodd line cells, and the second erase address period EA2 and the second sustain period S2 applied for the Xeven line cells. Meanwhile, the cells should have the light-emitting cell state so as to adopt an erase addressing method. However, the cells that have undergone a sustain discharge during the fourth subfield SF4 are given as being in the light-emitting cell state, and accordingly, the first erase address period is directly placed during the fifth subfield SF5, as shown in FIG. 7.

First, during the first erase address period EA1 of the fifth subfield SF5, a ground voltage 0V and a voltage Ve′ are respectively applied to the even-numbered and odd-numbered sustain electrodes Xeven and Xodd. At this time, in the FIG.2 embodiment, the scan pulse having the voltage Vscl is sequentially applied to the scan electrodes Y1 to Yn and the voltage Vsch is applied to the scan electrodes that are not applied with the voltage Vscl. Furthermore, in the FIG. 3 embodiment, the scan pulse having the voltage Vscl is sequentially applied to both of two adjacent scan electrodes Y1 and Y2, Y3 and Y4, and Y5 and Y6, and the voltage Vsch is applied to the scan electrodes that is not applied with the voltage Vscl. The voltage Ve′ is set to be less than the voltage Ve that is applied during the write address periods of the first to fourth subfields. The last sustain pulse is applied to the scan electrodes Y1 to Yn during the second sustain period S2 of the fourth subfield SF4, and accordingly during the sustain period of the fourth subfield, the negative (−) and the positive (+) wall charges are respectively formed on the scan and sustain electrodes of the cells that have undergone a sustain discharge. The sum of the wall voltage formed by the cells that have experienced a sustain discharge and the difference voltage Va′+|Vscl′| between the scan voltage Vscl′ and the address voltage Va′ generates a discharge between the scan electrode that is applied with the scan voltage Vscl′ and the address electrode that is applied with the address voltage Va′. The discharge is spread between the scan electrode and the odd-numbered sustain electrode Xodd that is applied with the voltage Ve′, and accordingly, the wall charges are erased so that the light-emitting cell state is changed into the non-light-emitting cell state. However, the erase address operation is not performed in the Xeven line cell even though the scan and address voltages Vscl′ and Va′ are applied because the even-numbered sustain electrodes Xeven are biased at the reference voltage 0V. Accordingly, a weak discharge is generated only between the scan and address electrodes even though the scan and address voltages Vscl′ and Va′ are respectively applied to the scan and address electrodes, and the discharge is not spread to the even-numbered sustain electrodes Xeven. The erase address operation can be performed by the scan voltage Vscl′ and the voltage Ve′ in the Xodd line cells formed by the odd-numbered sustain electrodes Xodd applied with the voltage Ve′. However, the erase address operation cannot be performed even by the scan voltage Vscl′ and the voltage Ve′ in the Xeven line cells formed by the even-numbered sustain electrode Xeven that are not applied with the voltage Ve′.

That is, the erase address operation can be performed depending on the application of the voltage Ve′. Therefore, the light-emitting cell state is changed into the non-light-emitting cell state only in the cells selected among the Xeven line cells during the first erase address period EA1 so that the erase address operation is performed in the selected cells.

Meanwhile, the voltage Ve′ applied during the first erase address period. EA1 is set to be less than the voltage Ve as described above. This is because the last sustain pulse is applied to the scan electrodes Y1 to Yn, and accordingly, the negative (−) and positive (+) wall charges are respectively formed on the scan and sustain electrodes of the cells that have undergone a sustain discharge so that the erase address operation can be operated even by the voltage Ve′ that is less than the voltage Ve in the cells that have undergone a sustain discharge during the sustain period of the fourth subfield SF4. However, since there are somewhat lesser wall charges after the reset period, the voltage Ve applied during the write address period of the first to the fourth subfields SF1 to SF4 is set to be somewhat higher. Meanwhile, in FIG. 7, the scan voltage Vscl′ and the non-scan voltage Vsch′ of the first erase address period EA1 may be set to be respectively substantially equal to the scan voltage Vscl and the non-scan voltage Vsch of the first to fourth subfields SF1 to SF4. This means that the erase operation of the first erase address period EA1 establishes the state of the cell that has undergone a sustain discharge as the non-light-emitting cell state. Accordingly, the scan and the non-scan voltages may be respectively set to be higher than each of the scan and the non-scan voltage of the write address period. In addition, the width of the scan pulse applied during the first erase address period EA1 may decrease more than that of the scan pulse applied during the write address period of the first to fourth subfields SF1 to SF4. Since the erase address operation establishes the light-emitting cell state as the non-light-emitting cell state, the width of the scan pulse may be reduced than that of the scan pulse of the write address operation discharge not to ensure the time for forming wall charges by the discharge.

In the first sustain period S1 of the fifth subfield SF5, the sustain pulse is alternately applied to the scan and sustain electrodes Y1 to Yn and Xodd and Xeven so that the sustain discharge is generated on the cell maintaining the light-emitting cell state. At this time, the number of the sustain pulses is appropriately selected corresponding to the weight values of the fifth subfield SF5.

Meanwhile, the sustain pulse applied in the first sustain period S1 serves to supplement the wall charges for the Xeven line cells, which are partly erased during the first erase address period EA1. As described above, the weak discharge is generated between the scan and address electrodes of the Xeven line cell even though the reference voltage 0V is applied to the even-numbered sustain electrodes Xeven when the scan and address voltages Vscl′ and Va′ are respectively applied to the scan and address electrodes during the first erase address period EA1. As a result, the wall charges formed on the address electrodes of the cells maintaining the light-emitting cell state among the Xeven line cells are erased, and accordingly, the erase addressing is not sufficiently performed during the second erase address period EA2. However, the erased wall charge is supplemented during the second sustain period S2. Although the wall charges are partly erased from the light-emitting cells among the Xeven line cells because the Xeven line cells are not selected during the first erase address period EA1, the sustain discharge is generated during the first sustain period S when the sustain pulse is applied, and accordingly the erased wall charges are supplemented by the sustain discharges.

Subsequently, the voltage Ve′ and the reference voltage 0V are respectively applied to the even-numbered and odd-numbered sustain electrodes Xeven and Xodd during the second erase address period EA2. In addition, in the first exemplary embodiment of FIG.2, the scan pulse having the voltage Vscl is sequentially applied to the scan electrodes Y1 to Yn and the scan pulse having the voltage Vsch is applied to the scan electrodes that are not applied with the voltage Vscl. Furthermore, in the second exemplary embodiment of FIG. 3, the scan pulse having the voltage Vscl is simultaneously applied to the two adjacent scan electrodes Y1 and Y2, Y3 and Y4, and Y5 and Y6, and the scan pulse having the voltage Vsch is sequentially applied to the scan electrodes that are not applied with the voltage Vscl. The non-light-emitting cells are selected among the even-numbered line cells during the second erase address period EA2 in the inverse of the first erase address period EA1, because the voltage Ve′ is applied only to the even-numbered sustain electrodes Xeven.

In addition, the sustain pulse is applied to the scan electrodes Y1 to Yn and the sustain electrodes Xodd and Xeven during the second sustain period S2. The sustain discharge is then generated in the cells maintaining the light-emitting cell state. At this time, the number of sustain pulses applied during the second sustain period S2 is set to be equal to the number of sustain pulses applied during the first sustain period S1 such that the sustain discharge number of Xodd line cells is in accord with that of the Xeven line cell. Meanwhile, the wall charges, which are partly erased or dissipated in the cell maintaining the light-emitting cell state among the Xodd line cells in the same manner as the first sustain period S1, are supplemented by the sustain discharge of the second sustain period S2 even during the second erase address period EA2. Therethrough, the Xodd line cells regularly performs an erase addressing operation during the first erase address period EA1 of the sixth subfield SF1 corresponding to the next subfield of the fifth subfield SF5.

In addition, the driving waveforms applied to the sixth to ninth subfields SF6 to SF9 are substantially the same as the driving waveform of the fifth subfield SF5 shown in FIG. 7. Accordingly, these driving waveforms will not be described in detail.

Meanwhile, there is a problem in the main reset operation because the wall charge states after the write address operation are different from that after the fifth subfield, that is, the wall charges are erased by the erase address operation. The reset operation may not be normally performed in the cells in which the wall charges are erased by the erase address operation because the main reset is designed to expect the write address operation.

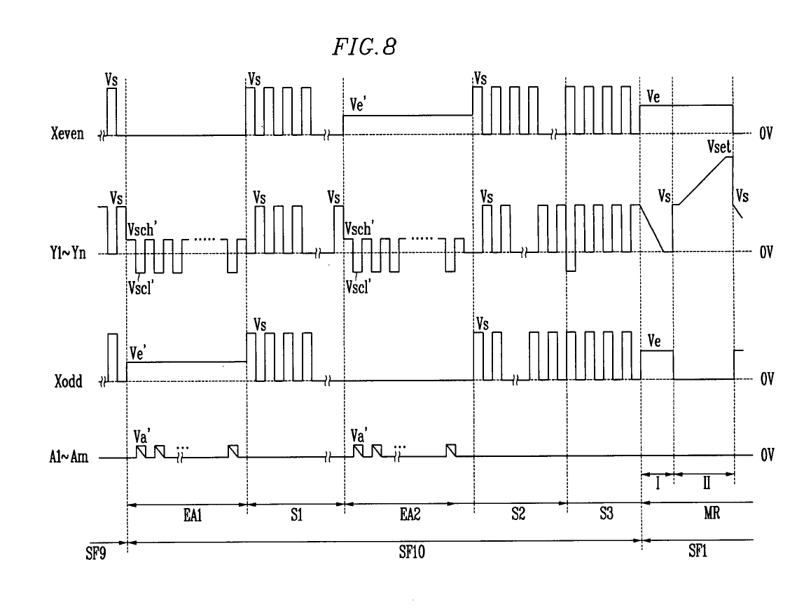

Therefore, at the odd-numbered frame, a driving waveform shown in FIG. 8 can be applied to the tenth subfield SF10 such that the main reset operation is stably performed for the next even-numbered frame.

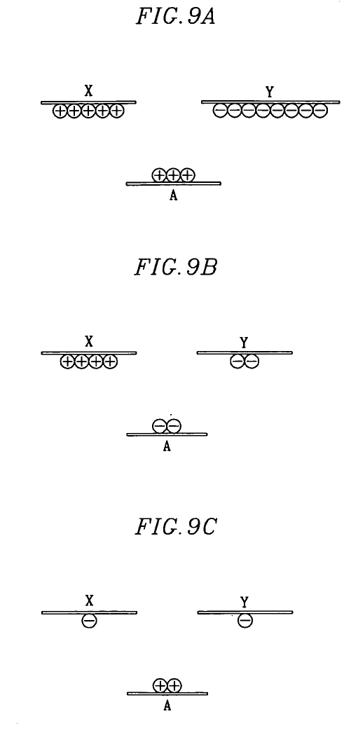

FIG. 8 shows a driving waveform applied to a tenth subfield SF10 among driving waveforms of the plasma display device according to the exemplary embodiment of the present invention. FIG. 9A to FIG. 9C respectively show a wall charge state according to the application of the driving waveform of the plasma display device shown in FIG. 8, in which for better convenience of description only one scan electrode Y, one address electrode A, and one sustain electrode X are illustrated among the plurality of scan electrodes Y1 to Yn, address electrodes A1 to An, and sustain electrodes Xodd and Xeven.

As shown in FIG. 8, the first erase address period EA1 and the first sustain period S1 applied for the Xodd line cells, the second erase address period EA2 and the second sustain period S2 applied for the Xeven line cells, and amend period M that is capable of controlling the wall charge state are included. The erase address periods EA1 and EA2 and the sustain periods S1 and S2 have been described with reference to FIG. 7. Accordingly, these periods will not be described in detail.

Generally, the wall charge state of the cells that have undergone a sustain discharge is given as FIG. 9A when the sustain pulse is applied to the scan electrodes Y1 to Yn at the fifth subfield SF5 to the tenth subfield SF10. That is, a large amount of the negative (−) wall charges are formed on the scan electrodes Y1 to Yn, and the positive (+) wall charges are formed on the sustain electrodes Xodd and Xeven and the address electrodes A1 to An.

At this time, the erase discharge is generated between the scan and address electrodes Y1 to Yn and A1 to An, and accordingly the wall charges are erased during the erase address period, when the cells are selected as the non-light-emitting cell state and the erase address operation is performed in the cells during the erase address period of the fifth to tenth subfields SF5 to SF10. That is, when the erase addressing operation is performed, the negative voltage Vscl′ is applied to the scan electrodes Y1 to Yn and the positive voltage Va′ is applied to the address electrodes A1 to An so that the negative (−) wall charges formed on the scan electrodes Y1 to Yn are largely erased, and a predetermined amount of the negative (−) wall charges are formed on the address electrodes A1 to An, as shown in FIG. 9B.

However, when the main reset period MR is performed at the first subfield SF1 of the even-numbered frame while forming the negative (−) wall charges on the address electrodes A1 to An as shown in FIG. 9B, a strong discharge is generated between the address and scan electrodes A1 to An and Y1 to Yn during the rising period II of the main reset period MR. Accordingly, the reset operation is not sufficiently performed.

Therefore, as shown in FIG. 8, a voltage Vs and a negative voltage Vb are respectively applied to the sustain electrodes Xeven and Xodd and the scan electrodes Y1 to Yn, and the ground voltage 0V and the voltage Vs are alternately applied to these electrodes during the amend period M.

At this time, the voltage Vb is set such that the voltage difference between the sustain electrodes Xeven and Xodd and the scan electrodes Y1 to Yn is less than the discharge firing voltage and greater than the voltage Vs. That is, the sustain discharge is generated in the cells in which the wall charges have been erased by the erase address operation, as well as the cells that have undergone a sustain discharge at the tenth subfield SF10. The cells that have undergone an erase address operation have the wall charge state as shown in FIG. 9B. However, the discharge is generated when a voltage having a difference that is greater than the voltage Vs is applied to the scan electrodes Y1 to Yn and the sustain electrodes Xeven and Xodd. Accordingly, thereafter, the discharge will be generated whenever the voltage is applied regardless of the voltage difference of the voltage Vs. Therefore, when the amend period M is performed, the cells that have undergone the erase addressing have substantially the same wall charge state as the cells that have undergone the sustain discharge as shown in FIG. 9A.

Therefore, the erase addressed cells are initialized from the wall charge state as shown in FIG. 9A when the weak reset discharge is generated between the Xeven line cells and the adjacent scan electrodes during the main reset period MR.

Meanwhile, when the amend period M is added, it may be difficult to express the entirety of grayscales. More specially, in the case of the cells that have experienced a sustain discharge between the fourth subfield SF4 and the tenth subfield SF10, the discharges are generated whenever the voltage is applied to the scan electrodes Y1 to Yn and the sustain electrodes Xeven and Xodd during the amend period M, and accordingly, a higher grayscale than the desired grayscale is expressed. However, since the number of sustain discharges generated during the amend period M can be controlled, and because the discharge generated during the amend period M is weak in comparison with the entire grayscale value in that the cell undergoes light-emitting at the subfield having a larger weight value, it has no large effect on the expression of the entire grayscales. Particularly, experimentally, the wall charge state that is appropriate for performing a main reset operation of the even-numbered frame is given when the voltages Vs and 0V are alternately applied about 3 times after the voltages Vs and Vb are respectively applied to the sustain electrodes Xeven and Xodd and the scan electrodes Y1 to Yn during the amend period M. There is no significant effect on the expression of the entire grayscale when the sustain discharge is generated a further 3 times.

In addition, in the case of the cells (i.e., Xodd line cells) in which the sustain discharge is generated between the first subfield SF1 and the third subfield SF3, and the sustain discharge is not generated after the fourth subfield SF4, the discharge may not be generated even during the amend period M. Accordingly, there is no large effect on the expression of the entire grayscale.

For example, in the case of the cell in which the sustain discharge is generated at the third subfield SF3 and the sustain discharge is not generated after the fourth subfield SF4, only the cells that have undergone a sustain discharge at the third subfield are initialized during the selective reset period SR of the fourth subfield SF4 the third subfield SF3. Accordingly, the wall charge state having the wholly erased wall charge as shown in FIG. 9C is maintained until the tenth subfield SF10 is finished. That is, since there is no wall charge to be erased during the erase address period in the cells that are not addressed at the fourth subfield SF4 after the fifth subfield SF5, the wall charge state as shown in FIG. 9C is maintained. At this time, the discharge is not generated because during the amend period M the difference of the voltages Vs and Vb applied to the sustain electrodes Xeven and Xodd and the scan electrodes Y1 to Yn is less than the discharge firing voltage. Therefore, the main reset operation of the even-numbered frame is performed at the maintained wall charge state as shown in FIG. 9C.

Meanwhile, according to an exemplary embodiment of the present invention, the amend period M is performed after the second sustain period S2 at the tenth subfield SF10. However, the amend period M may replace the second sustain period S2. That is, when the same number of discharge pulses is applied during the second sustain period S2 and during the amend period M, the time allocated in the tenth subfield SF10 may be reduced.

In addition, according to an exemplary embodiment of the present invention, the voltage difference between the scan and sustain electrodes Y1 to Yn and Xeven and Xodd increases when the voltage Vb applied to the scan electrodes Y1 to Yn decreases during the amend period M. However, the voltage difference between the scan and sustain electrodes Y1 to Yn and Xeven and Xodd may also increase when the ground voltage is applied to the scan electrodes Y1 to Yn and the voltage applied to the sustain electrodes Xeven and Xodd is greater than the voltage Vs.

As described above, according to an exemplary embodiment of the present invention, the number of scan circuits can be reduced when the number of electrodes are reduced such that the sustain and scan electrodes respectively share two adjacent display lines.

In addition, the wall charges are sufficiently initialized during the next main reset period by replacing the amend period for the predetermined period when the write address and erase address periods are mixed at the plurality of subfields.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of driving a plasma display device in which a plurality of cells are selectively turned on and off, comprising:
at a first subfield of a first frame, selecting on-cells by way of a first address scheme configured to convert on-cells into an off-cell state during an address period;
alternately applying a first voltage to a plurality of first and second electrodes of the plasma display device during a sustain period, the first voltage being a sustain discharge voltage and formed of a plurality of sustain pulses, wherein the difference between two selected sustain pulses, which are applied substantially simultaneously to the first and second electrodes, respectively, is defined as a second voltage;
increasing the second voltage to a third voltage that is greater than the first voltage during a first period; and
at a second subfield of a second frame, generating a sustain discharge after selecting on-cells by way of a second address scheme configured to convert the off-cells into an on-cell state.

2. The driving method of claim 1, wherein the sustain discharge is generated in a cell maintaining the on-cell state between the address and first periods of the first subfield.

3. The driving method of claim 1, wherein at the first period, the first voltage and a voltage that is less than a ground voltage are respectively applied to the plurality of first and second electrodes such that the second voltage becomes the third voltage.

4. The driving method of claim 1, wherein at the first period, the third voltage and the ground voltage are respectively applied to the plurality of first and second electrodes such that the second voltage becomes the third voltage.

5. The driving method of claim 1, wherein at the first period, a discharge is generated in the cells which have been converted to the off-cell state by the first address scheme during the address period of the first subfield.

6. The driving method of claim 1, wherein a voltage of the plurality of first electrodes is gradually increased and then decreased during the reset period of the second subfield.

7. The driving method of claim 6, wherein the first subfield belongs to the first frame and the second subfield belongs to the second frame that is consecutive to the first frame.

8. The driving method of claim 7, wherein the first and second frames respectively use the first address scheme and the second address scheme together.

9. The driving method of claim 7, wherein the first subfield is placed at the last part of the first frame.

10. The driving method of claim 1, wherein during the first period, a discharge is generated in the cells that have been converted to the off-cell state by the first address scheme during the address period of the first subfield.

11. The driving method of claim 1, wherein a sustain pulse having the first voltage is finally applied to the plurality of the first electrodes during the sustain period of the first subfield.

12. The driving method of claim 1, wherein a plurality of display lines are respectively formed between the plurality of first and second electrodes, and wherein two adjacent display lines share a selected one of the plurality of second electrodes.

13. The driving method of claim 1, wherein respective display lines are formed between a respective one of the plurality of first electrodes and a respective one of the plurality of second electrodes which is adjacent to the first electrode, and
a sustain pulse is simultaneously applied to every two first electrodes when the first and second address schemes are adopted.

14. The driving method of claim 2, wherein during the first period, a voltage configured to change the second voltage into the first voltage is applied three or more times after a voltage configured to change the second voltage into the third voltage is applied to the plurality of first and second electrodes.

15. A method of driving a plasma display device, comprising:
at a first subfield of a first frame,
selecting on-cells by way of a first address scheme configured to convert on-cells into an off-cell state;
generating a sustain discharge for the selected cells with the use of a plurality of first scan pulses having substantially the same pulse height;
during a first period, generating a discharge for the cells which have been converted into the off-cell state with the use of a plurality of second scan pulses, wherein at least one of the plurality of second scan pulses is greater in magnitude than the plurality of first scan pulses; and
at a second subfield of a second frame, generating a reset discharge so as to initialize all the discharge cells.

16. The driving method of claim 15, wherein a second address scheme is configured to convert off-cells into an on-cell state is applied during the second subfield.

17. The driving method of claim 15, wherein the reset discharge is generated when the voltage of the plurality of first electrodes is gradually increased and then decreased.

18. A plasma display device comprising:
a plasma display panel (PDP) including a plurality of first electrodes, a plurality of second electrodes, and a plurality of third electrodes formed so as to cross the first electrodes and the second electrodes, wherein the PDP includes a plurality of cells which are selectively turned on and off in a frame, and wherein the frame is divided into a plurality of subfields; and
a driver configured to drive the plurality of first and second electrodes such that a voltage difference between the plurality of first and second electrodes is greater than a first voltage during a first period between a first subfield and a second subfield,
wherein in the first subfield, the first voltage is alternately applied to the plurality of first and second electrodes by way of a first address scheme which is configured to convert on-cells into an off-cell state during a sustain period, and wherein in the second subfield a second address scheme is used to convert off-cells into an on-cell state.

19. The plasma display device of claim 18, wherein the driver generates a sustain discharge in the cells maintaining the light-emitting cell state after the address period of the first subfield during a second period between the address and first periods of the first subfield.

20. The plasma display device of claim 18, wherein the driver respectively applies the first voltage and a voltage that is less than a ground voltage to the plurality of first and second electrodes during the first period.

21. The plasma display device of claim 18, wherein the driver respectively applies the ground voltage and a voltage that is greater than the first voltage to the plurality of first and second electrodes during the first period.
